(19) United States
(12) Patent Application Publication
(10) Pub. No.: US 2014/0076000 A1
(43) Pub. Date: Mar. 20, 2014

(54) APPARATUS AND METHOD FOR AIR FLOW CONTROL DURING MANUFACTURE OF GLASS FIBER INSULATION

(71) Applicant: Timothy James Johnson, Traverse City, MI (US)

(72) Inventor: Timothy James Johnson, Traverse City, MI (US)

(21) Appl. No.: 13/623,229

(22) Filed: Sep. 20, 2012

(51) Int. Cl. C03B 37/10

(52) U.S. Cl. CPC C03B 37/10
USPC 65/505

(57) ABSTRACT

Apparatus, systems and methods for controlling the amount of air introduced into the forming hood area in the manufacture of mineral fiber insulation products utilize one ore more cyclonic separators to remove great quantities of moisture, heat and air before laying fibers down on a collection surface, such as a conveyor. In some embodiments, binder is applied (if at all) only after the cyclonic separator, so that any presence of binder chemicals in emissions or downstream forming components is minimized. The system reduces the many air, moisture and energy inefficiencies existing in present forming systems.

### RELATED APPLICATIONS

This application claims priority from U.S. provisional patent application No. 61/538,243, filed on Sep. 23, 2001, titled “Apparatus and Method for Air Flow Control During Manufacture of Glass Fiber.” U.S. provisional patent application No. 61/538,243 is incorporated herein by reference in its entirety.

### BACKGROUND

This invention relates in general to insulation products made from mineral fibers such as fibrous glass and, in particular, to methods and apparatus for controlling product properties by controlling air flow and moisture in a forming hood.

Fibrous glass insulation products generally comprise randomly-oriented glass fibers bonded together by a cured thermosetting polymeric material. Molten streams of glass are drawn into fibers of random lengths and blown into a forming chamber or hood where they are randomly deposited as a pack onto a moving conveyor or chain. The fibers, while in transit in the forming chamber and while still hot from the drawing operation, are sprayed with an aqueous dispersion or solution of binder. The residual heat from the glass fibers and from the flow of hot gases during the forming operation are sufficient to vaporize much of the water from the binder, thereby concentrating the binder dispersion and depositing binder on the fibers as a viscous liquid with high solids content. Further water may be removed by drying the binder on the fibers. As the water vaporizes, the energy transfer also cools the glass fibers. The uncured fibrous pack is transferred to a curing oven where heated air, for example, is blown through the pack to cure the binder and rigidly bond the glass fibers together in a generally random, three-dimensional structure known as a “blanket.” For many products, sufficient binder is applied and cured so that the fibrous blanket can be compressed for packaging, storage and shipping, yet regains its thickness—a process known as “loft recovery”—when installed. Other products become “loose fill” products and may not require binder.

### SUMMARY OF THE INVENTION

This invention relates to apparatus, systems and methods for monitoring and controlling the amount of moisture introduced into the forming hood area in the manufacture of mineral fiber insulation products so that the products have improved properties.

Thus in one aspect, the invention relates to a manufacturing system for making a fibrous mineral product, said system comprising:
at least one fiberizing unit adapted to form fibers from a source of molten mineral, and a blower for generating a flow of gas for deflecting and transporting the fibers;
at least one cyclonic separator having separator inlet for receiving the gas flow and fibers, walls shaped to decrease the momentum/velocity of fibers relative to the momentum/velocity of transporting gas, thereby dissociating the fibers from the transporting gas, a primary outlet for egress of the transporting gas, and a secondary outlet for egress of dissociated fibers; and
a collection surface disposed proximate to the secondary outlet for receiving the dissociated fibers to form a fibrous pack.

The fiberizing unit may comprise a rotary or spinner fiberizer and there may be multiple fiberizers in one forming line. In the case of multiple fiberizers there may be multiple cyclone separators as well, although the number of each may or may not coincide. The collection surface may comprise an endless loop or other type of conveyor.

The separators may be arranged with a vertical main axis or a horizontal main axis; and with a secondary outlet oriented downward toward the collection surface or transverse to the collection surface. In some embodiments, the separators may be arranged over the collection surface substantially in-line with the machine direction. Alternatively, the separators may be arranged over the collection surface with at least two separators adjacent one another in the cross machine direction; or with at least two separators staggered so as to be neither in-line, nor adjacent.

The systems may include sprayers for spraying coolant water; and they may be located upstream of cyclone separator inlet. The systems may also include sprayers for applying binder; and these may be disposed downstream from secondary cyclone outlet or inside the cyclone near the secondary outlet.

In another aspect, the invention includes a method of making a fibrous mineral product comprising using the systems described above. For example, a method may comprise:
attenuating molten mineral into fibers with at least one fiberizing unit,
transporting the fibers via a high velocity flow of gas into a cyclonic separator, the cyclonic separator having a tangential inlet for receiving the gas flow and fibers, walls shaped to decrease the momentum/velocity of fibers relative to the momentum/velocity of transporting gas, thereby dissociating the fibers from the transporting gas, a primary outlet for high velocity egress of the transporting gas, and a secondary outlet for low velocity egress of dissociated fibers; and
directing the fibers from the second outlet onto a collection surface to form a fibrous pack.

The fibers may be formed by a spinner or rotary-type fiberizer or any other type of fiberizer. The method may further comprise spraying coolant water on the fibers, which may occur upstream of the separator inlet. The method may further comprise spraying binder on the fibers, which may occur in the cyclone near the second outlet or downstream from the second outlet.

The method may include concentrating the fiber density in air by at least 500 fold in the cyclonic separator. The method may include slowing the fiber velocity from an initial high velocity of at least 3000 fpm upon entry into the cyclone separator, to a low velocity upon egress of not more than about 1,000 fpm, 500 fpm or 50 fpm.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a partially sectioned side elevation view of a forming hood component of a manufacturing line for manufacturing fibrous products;

FIG. 2 is a schematic representation of novel forming system in accordance with the invention;

FIG. 3 is perspective view of a typical cyclonic separator; and

FIGS. 4A-4E are schematic representations of various embodiments or configurations of cyclonic separators used in a manufacturing line.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including books, journal articles, published U.S. or foreign patent applications, issued U.S. or foreign patents, and any other references, are each incorporated by reference in their entireties, including all data, tables, figures, and text presented in the cited references.

In the drawings, the thickness of the lines, layers, and regions may be exaggerated for clarity.

Unless otherwise indicated, all numbers expressing ranges of magnitudes, such as angular degrees or sheet speeds, quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

“Mineral fibers” refers to any mineral material that can be melted to form molten mineral that can be drawn or attenuated into fibers. Glass is the most commonly used mineral fiber for fibrous insulation purposes and the ensuing description will refer primarily to glass fibers, but other useful mineral fibers include rock, slag and basalt.

“Product properties” refers to a battery of testable physical properties that insulation batts possess. These may include at least the following common properties:
“Recovery”—which is the ability of the batt or blanket to resume its original or designed thickness following release from compression during packaging or storage. It may be tested by measuring the post-compression height of a product of known or intended nominal thickness, or by other suitable means.
“Stiffness” or “sag”—which refers to the ability of a batt or blanket to remain rigid and hold its linear shape. It is measured by draping a fixed length section over a fulcrum and measuring the angular extent of bending deflection, or sag. Lower values indicate a stiffer and more desirable product property. Other means may be used.
“Lateral weight distribution” (LWD or “cross weight”)—which is the relative uniformity or homogeneity of the product throughout its width. It may also be thought of as the uniformity of density of the product, and may be measured by sectioning the product longitudinally into bands of equal width (and size) and weighing the band, by a nuclear density gauge, or by other suitable means.
“Vertical weight distribution” (VWD)—which is the relative uniformity or homogeneity of the product throughout its thickness. It may also be thought of as the uniformity of density of the product, and may be measured by sectioning the product horizontally into layers of equal thickness (and size) and weighing the layers, by a nuclear density gauge, or by other suitable means.
   Of course, other product properties may also be used in the evaluation of final product, but the above product properties are ones found important to consumers of insulation products.

Unless otherwise defined, “vapor” and ‘water vapor” are used interchangeably to refer to coolant or binder diluent liquid, typically water, in a gaseous phase.

### Manufacturing System Overview

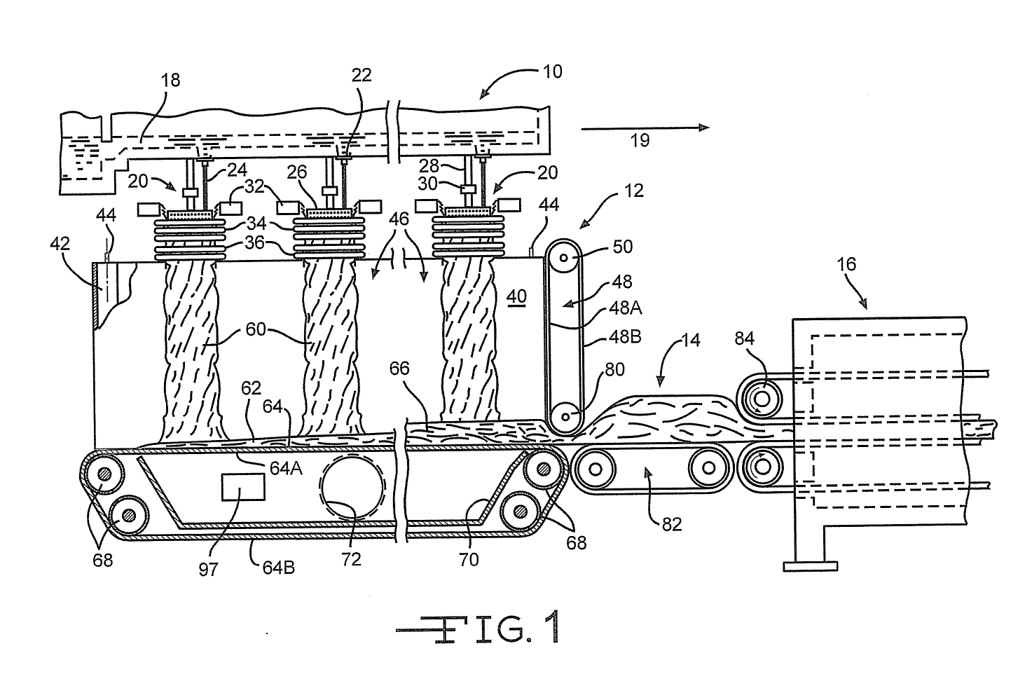

FIG. 1 illustrates a glass fiber insulation product manufacturing line including a forehearth 10, forming hood component or section 12, a ramp conveyor section 14 and a curing oven 16. Molten glass from a furnace (not shown) is led through a flow path or channel 18 to a plurality of fiberizing stations or units 20 that are arranged serially in a machine direction, as indicated by arrow 19 in FIG. 1. At each fiberizing station, bushings or holes 22 in the flow channel 18 allow a stream of molten glass 24 to flow into a spinner 26, which may optionally be heated by a burner (not shown). Fiberizing spinners 26 are rotated about a shaft 28 by motor 30 at high speeds such that the molten glass is forced to pass through tiny orifices in the circumferential sidewall of the spinners 26 to form primary fibers. Blowers 32 direct a gas stream, typically air, in a substantially downward direction to impinge the fibers, deflecting them downward and attenuating them into secondary fibers having a diameter from about 2 to about 9 microns, or from about 3 to about 6 microns. The fibers form a veil 60 that is forced downwardly and may be distributed in a cross-machine direction by mechanical or pneumatic “lappers” (or other means, not shown), eventually forming a fibrous layer 62 on a porous conveyor 64. The layer 62 gains mass (and typically thickness) with the deposition of additional fiber from the serial fiberizing units, thus becoming a fibrous “pack” 66 as it travels in a machine direction 19 through the forming area 46.

One or more cooling rings 34 spray coolant liquid, such as water, on veil 60 to cool the forming area and, in particular, the fibers within the veil. Other coolant sprayer configurations are possible, of course, but rings have the advantage of delivering coolant liquid to fibers throughout the veil 60 from a multitude of directions and angles. For some insulation products, a binder dispensing system includes binder sprayers 36 to spray binder onto the veil 60. Illustrative coolant spray rings and binder spray rings are disclosed in US Patent Publication 2008-0156041 A1, to Cooper, incorporated herein by reference. Each fiberizing unit 20 thus comprises a spinner 26, a blower 32, one or more cooling liquid sprayers 34, and one or more binder sprayers 36. FIG. 1 depicts three such fiberizing units 20, but any number may be used. For typical insulation products, from two to about 15 units, typically 3 to about 12 units, may be used in one forming hood component for one line.

The extreme heat of the forming hood environment can cause binder problems. Binder is normally dispensed as a solution or dispersion of binder solids in an aqueous vehicle. The heat can evaporate the binder vehicle, causing viscosity increases that lead to sticky binder, clumping or agglomeration, and poor product properties such as vertical weight distribution. The binder may actually burn off or “flash”, causing unwanted volatiles in the emissions. For this reason, it is typical to spray coolant liquid on the fibers and into the environment in quantities sufficient to prevent these undesirable binder viscosity and flashing problems. This adds considerable moisture to the forming hood and to the pack 66 as it forms.

The porous conveyor 64 contains numerous small openings allowing the air flow to pass through while links essentially filter the fibers and support the growing fibrous pack. A suction box 70 connected via duct 72 to fans or blowers (not shown) are additional production components located below the conveyor chain 64 to create a negative pressure and remove air injected into the forming area 46. As the conveyor chain 64 rotates around its rollers 68, the uncured pack 66 exits the forming section 12 under exit roller 80, where the absence of downwardly directed airflow and negative pressure (optionally aided by a pack lift fan, not shown) allows the pack to regain its natural, uncompressed height or thickness. A subsequent supporting conveyor or “ramp” 82 leads the uncured fibrous pack toward a curing oven 16 and between another set of porous compression conveyors 84 for shaping the pack to a desired thickness for curing in the oven 16. Upon exit from the oven 16, the cured pack or “blanket” (not shown) is conveyed downstream for cutting and packaging steps. For some products, the blanket is split longitudinally into multiple lanes and then chopped into shorter segments known as “batts.” These may be bundled or rolled for packaging.

The forming hood section or component 12 is further defined by at least one hood wall 40, and usually two such hood walls on opposing sides of the conveyor chain 64 to define a forming chamber or area 46. For clarity in FIG. 1, the hood wall 40 is depicted on only one side (behind conveyor chain 64), and a portion of the wall 40 on the left end is removed to reveal a roller 42. Typically, each of the hood walls 40 takes the form of a loop or belt having an inward-directed flight and an outside flight. The inward-directed flight defines a sidewall of the forming area 46 and moves through the forming area by rotating about vertical rollers 42; while the outside flight closes the loop outside of the forming area 46. End walls 48 (one shown at the right end of the forming area 46) of similar belt construction may further enclose the forming area 46 with an inward facing flight 48A and an outward return flight 48B. As shown in FIG. 1, however, the rollers 50, 80 for the end wall 48 may be oriented transversely compared to the rollers 42. A similar end wall (not shown) may be present on the left end of the forming area 46. The terms “forming hoodwall”, “hoodwall” and “hood wall” may be used interchangeably herein to refer to the wall(s) that define and enclose the forming area 46.

The above description of FIG. 1 relates to one way glass fiber insulation products have been made in the past. There are some inefficiencies in this process however, relating to the air flow, moisture and heat put into and then removed from the pack. The present invention seeks to overcome many of these inefficiencies.

Much air is introduced into the forming hood area as a result of the blowers 32 and the lappers (not shown) and entrained ambient air that gets pulled along with these. Yet most of this air does not remain in the pack and must be eliminated by the suction fan and ultimately the discharge stack. The blowers 32 and suction fan tend to thrust the fibers onto the conveyor 64 with high momentum and velocity, and continue to compress them there while in the forming hood. But to obtain a desired R-value, insulation must regain a certain loft or thickness, so this compression represents “air flow inefficiency.” An example of this air flow inefficiency follows.

In one embodiment of a rotary fiberizing operation, the air flow away from each fiberizer is typically in the range of 10,000 to 15,000 standard cubic feet per minute (“scfm”). If one assumes a glass flow rate of 20 pounds per minute at each fiberizer, then in one minute 20 pounds of glass will experience 10,000 scf of air for a glass-mass to air-volume ratio (i.e. a density) of about 0.001-0.002 pounds/cubic foot (“pcf”). In contrast, a finished insulation product may have a density of about 0.3 to 10 pcf, depending on the type of product. For example, typical residential insulation generally has a density of about 0.3 to 4 pcf. Thus, so much air is removed from the final product that the density increases approximately 3-4 orders of magnitude! This represents a great deal of “wasted” or inefficient use of air in the manufacturing process. This is just one example. Larger or smaller fiberizers, non-rotary fiberizers, and virtually any number of fiberizers in a forming hood are also useful with this invention.

Similarly, much water is introduced via the coolant sprayers 34 and potentially the binder sprayers 36. While some of this moisture is important for carrying binder and cooling the fibers, the final pack contains little moisture, most of it having been dried by the oven 16. This represents “moisture inefficiency.” For example, an uncured pack entering the oven may have a moisture content in the range of about 5% to about 12% water; yet a finished product has essentially no moisture. Thus, for very pound of glass that goes into the oven about 0.05 to 0.13 pounds of water has to be removed by evaporation in the oven. For example, about 1 to 2 gallons per minute (8.3 to 16.6 pounds per minute) of coolant water may be added at each fiberizer. Additionally, about 1.3 to 1.8 gallons per minute of binder (about 10.79 to 14.94 pounds per minute) could be added at each fiberizer, and a conservative assumption is that 90% of this weight is due to the water. Thus about 18 to about 30 pounds per minute of liquid water are input into the forming hood per fiberizer. At the assumed 20 pounds per minute of glass per fiberizer, this equates to about 0.9 to 1.5 pounds of water per pound of glass. It is thought that this invention could reduce the water input in the forming operation by as much as one-third, or one-half, or more.

Finally, a great deal of heat energy is input to create the molten mineral (glass). To prevent binder flashing and viscosity problems, much of this heat is removed by evaporation of the coolant and binder water, but then the pack is then heated up again to dry out the moisture and cure the binder. It is then cooled again prior to packaging. This cycling of temperature represents “heat inefficiency.” For example, the molten glass is fiberized typically at a temperature of about 1900-2200 F. But this is cooled to a temperature of about 70-90 F by the time it accumulates on the ramp just prior to the oven. The pack is heated again in the oven, this time to a temperature in the range of about 400-550 F. Finally it is cooled to about 60-90 F before packaging. The energy to heat, then cool, then heat again, then cool the fiberglass is inefficient. In particular, the temperature on the ramp would not need to be so low with the invention, so that less cooling and reheating is required.

### Cyclonic Separation in Manufacture of Fibrous Insulation Products

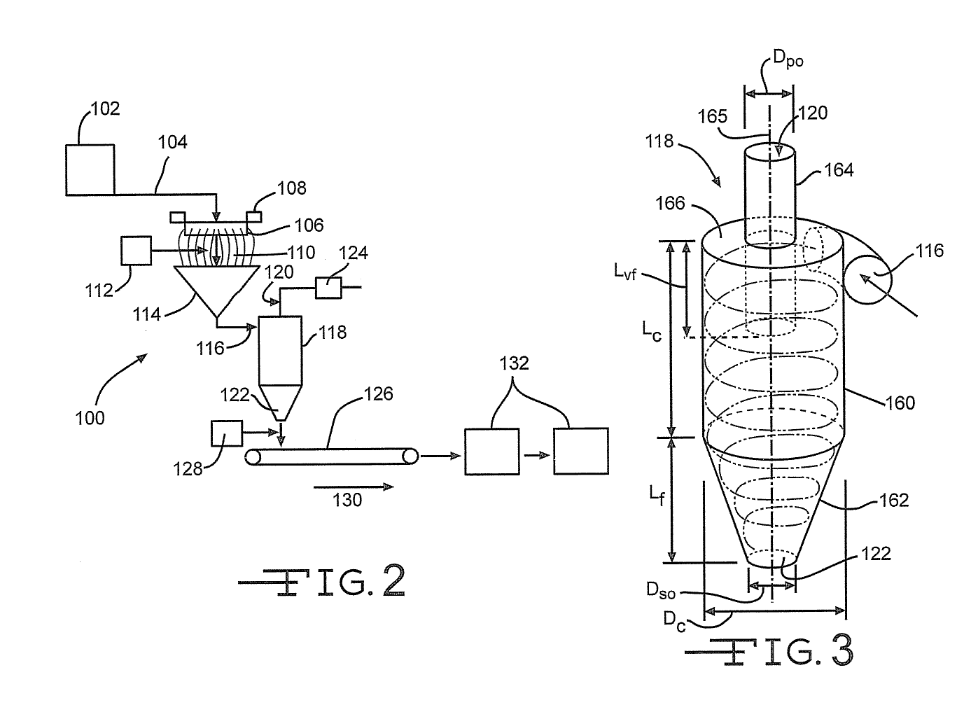

FIG. 2 illustrates schematically a novel system 100 for manufacture of fibrous products, such as insulation made from glass fibers. Some components are essentially the same as described above, while others are different. A furnace 102 supplies molten glass along a forehearth 104 to a spinner 106. The spinner rotates to force molten glass through orifices as primary fibers and air blowers 108 deflect and attenuate the primary fibers into a veil 110 of secondary fibers. The above-mentioned components are all essentially the same as those described above in connection with FIG. 1. However, known fiberizing apparatuses other than spinners are also possible with the invention

Sprayer 112 may optionally spray coolant liquid, e.g. water, on the fibers of veil 110 to cool them. Although the coolant fluid is optional, it is preferable to cool the fibers somewhat, at least enough that they do not stick to transporting duct work. However, it is notable that binder need not be, and preferably is not, applied at this point, so cooling the fibers to the extent necessary to avoid binder viscosity problems is not required. This means less coolant liquid is required and less moisture is introduced to the system.

A funnel or chute 114 is oriented to catch the fibers as they are blown into the veil 110. The chute should be of a diameter and construction to capture substantially all the glass fibers and not impede their flow while transporting them downstream. Such chutes are already well known in manufacture of loose-fill glass fiber insulation products. They may be from about 12 inches to about 36 inches in diameter, more typically from about 14 to about 24 inches; and made of a material that can withstand the heat and abrasion, such as metal or high performance plastics. In one embodiment, the chute is at least partially made using AR400 abrasion resistant steel. The transport chute 114 may be straight or curved and can even bend as long as it has large enough cross sectional area and the glass/air ratio is low enough to prevent flow impedance and/or plugging, as is well understood in the art of fluid mechanics and multiphase flow. Coatings, such as Teflon® or other lubricants, may be used to facilitate the flow of the air and fibers through the chute 114.

Chute 114 transports the fibers to the separator inlet 116 of a cyclonic separator 118. As is known in the field, the inlet 116 is generally oriented tangentially to a cylindrical/conical body. A primary outlet 120 allows egress or exit of the high velocity transporting gas (e.g. air), while a secondary outlet 122 allows egress or exit of the collected particles, whose velocity is slowed by operation of the separator. A pump, blower or fan 124 may be employed in the exit line of the primary outlet 120 to maintain the high velocity of the transporting air and reduce or eliminate any backpressure in the system. The blower or fan 124 should be capable of producing airflow rate/velocity of from about 8,000 to about 12,000 scfm, or from about 9,000 to about 10,000 scfm at each fiberizer. This is a clear energy advantage over the standard forming hoods where about 15,000 scfm is generated, as discussed above in connection with air inefficiencies. Cyclonic separators and the principles behind their operation are discussed further below.

From the outlet 122 of the separator 118, fibers fall or are led to a collection surface, such as conveyor 126. Notably, the velocity of the fibers is slowed to essentially a terminal velocity under the influence only of gravity. They are gently laid down on the conveyor 126 without the suction and compression traditionally found in the forming area due to the blowers 32, lappers, suction box 70 and associated fans or blowers (see FIG. 1). This enables the pack to be created without the influence of compression, which enables higher pack heights and thicknesses and more uniform vertical weight distribution in the pack.

If desired, a binder may be applied to the fibers. Binder 128 may be sprayed upon exit from the secondary outlet 122, using conventional spray rings or an equivalent sprayer. Binder may also be applied within the cyclonic separator near its secondary outlet 122. Alternatively, binder may be applied after the fibers are laid down in the pack on the conveyor 126, and in this case a linear array (cross-machine direction) of sprayers may uniformly distribute binder throughout the pack. The pack builds in mass and height on the conveyor 126 as the top flight of the conveyor 126 moves in the machine direction (arrow 130). The pack then progresses to an oven for curing the binder and then on to subsequent stations 132 for packaging prior to storage and/or transporting.

A significant advantage of the manufacturing system described above is that many of the inefficiencies noted above are reduced or eliminated. In accordance with the invention initial air velocity is similar to conventional forming operations so that the primary fibers from the spinner are attenuated into the proper size for secondary fibers, e.g. about 2 to 9 microns. However, at least about 90%, typically at least 95% of this air flow is removed via the cyclonic separators and never reaches the conveyor and pack forming area. Instead, most of the air is discharged or exhausted via the primary outlets 120.

Several corollary advantages stem from this. Improved pack thickness and more uniform vertical density have already been mentioned. However, since binder is not applied until after removal of most of the air, virtually no binder ends up in the emissions discharge. This has favorable environmental and operational implications. No scrubbers are needed to remove volatile organics; the exhaust is basically water vapor. Secondly, since the airflow is reduced drastically prior to application of binder, binder is not sucked into downstream air components such as suction boxes, forming fans, drop out boxes and the like. Some binders are acidic and corrosive, so it is highly advantageous to keep it out of downstream components. Additionally, the binder solids content can be increased, thus concentrating the binder solution and reducing the amount of water used. Finally, the gentle velocities of the fibers in the conveyor area allows for additional means to achieve better cross machine uniformity. The fibers are not driven onto the conveyer by high air flow and held there by suction, so less aggressive side-to-side distribution means is effective.

Other advantages of cyclonic separation of fibers and application of binder post separation are also to be realized. The residence time of particles in the separator and the pure absolute distance from the heat of the forehearth and fiberizing units allows the fibers to cool more naturally. The application of binder to cooler fibers reduces the viscosity problems mentioned above. But, in addition, less coolant liquid is required which, in turn, reduces the amount of moisture introduced into the pack, and the amount of washwater that must be collected and recycled. Less moisture in the pack means less drying time and energy and improves operational efficiency. Less binder may be needed as well, since there is no force sucking it through the conveyor to end up wasted on downstream production components.

Finally, there are additional oven efficiencies too. Less moisture translates into faster drying times as noted above. But in addition, the heat profile is less problematic. In the traditional method, fibers are heated to around 1800-2200 F to form molten glass. These are quickly cooled to around 400-600 F to apply binder (more typically from about 480 to about 580 F), introducing a steep gradient in the temperature profile. Then they cool further as they travel to the conveyor to a minimum of about 70-90 F that occurs somewhere on the ramp near the oven entrance, creating a large overall temperature delta from molten to ramp of about 1700 to more than 2000 F. In the oven, the fibers are heated up again to approximately 400-550 F to drive off moisture and cure the binder. They are later cooled again for storage and transportation. In contrast, in the present invention, the overall temperature delta is not as large, since temperatures of as much as about 200 F or more may be an acceptable minimum at the ramp.

In the present invention, the cyclone removes both the heat content and the convective heat transfer effect of the hot forming sir. This lessens the heat load for the coolant and binder dispersion water. The binder can be applied right after the excess air is removed and begin its curing reaction almost immediately upon contact with the fibers; and the fibrous pack does not have to recover against the forces of viscous binder to regain its loft from the aerodynamic compression of the forming hood. It may even be possible to eliminate coolant water completely; the combination of cooling and binder dispersion water need only be enough to get the binder to spray out of a nozzle onto the fibers and flow to fiber junctions, but the binder does not have to stay below any viscosity threshold, thus enabling higher binder solids content and higher application temperatures. Reheating in the oven takes less energy as well.

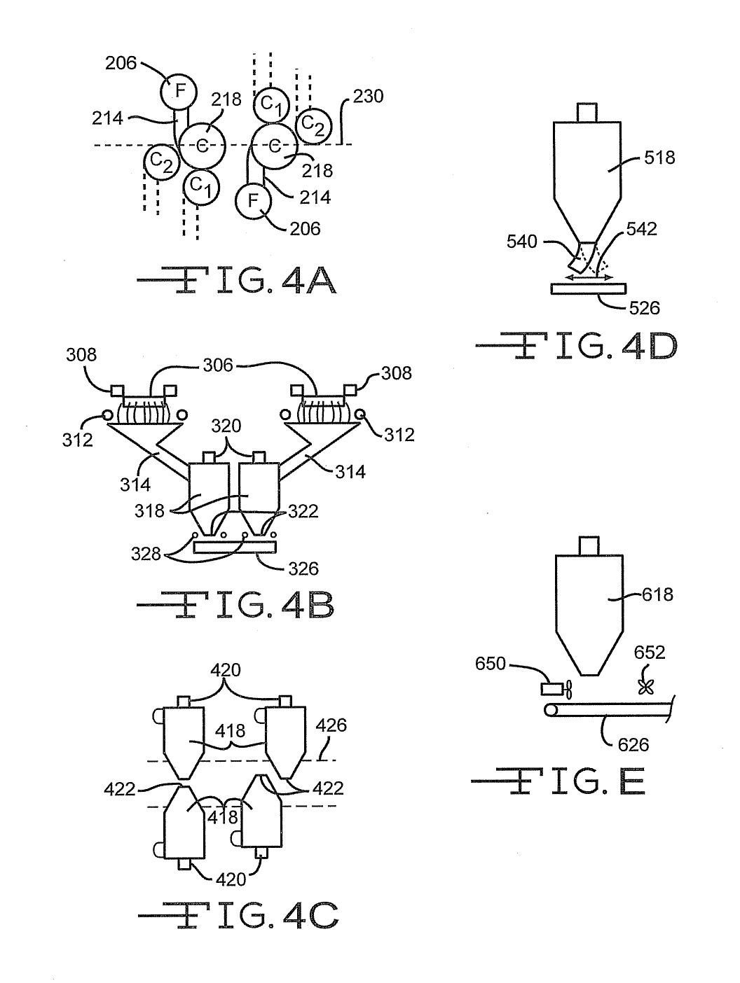

FIGS. 4A to 4E show a number of different configurations of cyclonic separators in a manufacturing line and each illustrates a particular means of achieving good uniformity in the cross machine direction. Each shows only a fraction of the 2 to 15 units that might be present on a real manufacturing line, it being understood that the configurations shown may be repeated as necessary. In FIG. 4A, a top plan view, two fiberizing units (F) are shown 206 each having a conduit 214 directing the fibers to a cyclonic separator (C) 218 shown in vertical orientation directly over a conveyor. Line 230 represents a line parallel to the conveyor direction. Two or more cyclonic separators may be arranged “in-line” with the machine direction as represented by the two positions “C” along the dashed line MD. Alternatively, two or more cyclonic separators may be arranged in adjacent, cross machine directions as shown by positions C, C1, or in staggered relationship as shown by positions C, C2, which is neither in-line nor adjacent. Cyclonic separators C1 and C2 are shown with dashed lines representing conduits to fiberizing units (not shown) that would supply them. Depending on the width of the conveyor, any number of cyclonic separators C might be arranged in any such manner to provide adequate coverage of the conveyor width. In each case the secondary outlets are arranged proximate to the conveyor. “Proximate” means within a distance near enough that the low velocity of egress carries the fibers to the conveyor directly or with the aid of a chute or deflector channel.

FIG. 4B is an end view of two cyclonic separators 210 arranged adjacent one another as are C, C1 in FIG. 4A above. In analogous fashion to FIG. 2, the two fiberizing spinners 306 produce fibers that are attenuated and directed downward by blowers 308 into respective chutes 314 and led to tangential inlets of the cyclonic separators 318. Coolant liquid sprayers 312 circumscribe the veil of fibers and cool them. The bulk of the inlet air is removed at primary outlet 320, while the fibers drop out of secondary outlet 322 onto the conveyor 326. Binder is sprayed onto the fibers by spray rings 328. Two or more such separators may be required to cover the width of the conveyor.

FIG. 4C is a top plan view of alternate configurations with cyclonic separators 418 with their main axes arranged horizontally. As noted, since the gravitational component of force is relatively small, it is possible to arrange cyclonic separators horizontally. Secondary outlets 422 are arranged proximate to the conveyor 426 to deposit fibers on the conveyor. For horizontal separators 418, a deflector or tangential secondary outlet may be used to aid in distribution in the cross machine direction. Alternatively or additionally, the egress velocity may be kept slightly higher to allow distribution across the conveyor. The arrangement of two separators may be adjacent, as for the left-most pair shown in FIG. 4C, or staggered, as for the right-most pair shown in FIG. 4C, or a combination of these. Primary outlets 420 are disposed facing outward away from the conveyor 426. As noted elsewhere, primary outlets may be coupled together in a manifold fashion.

FIG. 4D is an end view of a variation for distributing fibers in the cross machine direction. Fibers from this cyclonic separator 518 drop into a chute or deflector 540 that alternately moves side to side, as shown in phantom and represented by arrow 542, to distribute fibers across the full width of conveyor 526. Deflectors such as this are known in the industry as “buckets” and may swing on a pivot or rotate about an axis to extremes (right and left in FIG. 4D) of the conveyor width.

Finally, in FIG. 5E a configuration is shown in side elevation view. Cyclonic separator 618 drops fibers onto conveyor 626. A gentle fan 650 blowing generally in the machine direction may oscillate from side to side to distribute fibers in the cross-machine direction. Alternatively or additionally, a pair of gentle lateral fans 652 (only one shown) may direct fibers from side to side in the cross machine direction, in a manner analogous to the lappers in conventional usage. While these gentle fans may introduce some airflow in the conveyor area, it is nothing compared to the conventional forming arrangements. For example, typical exhaust fans are sized for about several hundred horsepower (hp), whereas the lateral or cross-lapping fans are sized at less than 10 hp, typically only a few hp.

In any configuration, the secondary outlets will be arranged somewhat over the conveyor, so that the glass fibers may be gently laid down on the conveyor. The primary outlets may be in an upward or outward direction, depending on the vertical or horizontal nature of the configuration. In either case, some embodiments may connect the primary outlets of two or more cyclonic separators together in fluid communication, so that a single fan or blower may extract air from multiple separators. In each configuration, the cyclonic separators may be arranged vertically or horizontally, although it is thought that vertical arrangement may produce better results.

Of course, batts or blankets are but one form of fibrous insulation. Other forms include loose-fill or “blown-in” insulation that may or may not require binder. Other glass fiber products that may benefit from this invention are thinner non-woven products such as mats or veils, which might be used as reinforcement in composite plastic parts and/or as substrates for shingle manufacture.

### General Principles of Cyclonic Separation

FIGS. 2 and 4, described above, show various embodiments of the invention, each of which operates on the principle of cyclonic separation of the glass fibers from the air flow. The principles of cyclonic separation are well understood by those skilled in the art, more typically applied to dust or dirt particles in air streams. Discussions on the types and uses of cyclones are in books such as “CHEMICAL ENGINEERING”, Vol. 2, by J. F. Richardson, J. H. Harker, J. R. Backhurst, Fifth Edition, 2002, Elsevier, Section 1.6.2 (b) (p. 72) and Section 9 (p. 475) and “PERRY'S CHEMICAL ENGINEERS' HANDBOOK” by R. H. Perry et al., Seventh Edition, Chapter 17, pp 26-32, McGraw Hill. The contents of these references are part of the common general knowledge of a person skilled in the art, and are in corporate herein by reference.

FIG. 3 shows a typical cyclone separator 118, including that previously mentioned tangential inlet 116, the primary outlet 120 and secondary outlet 122. The cyclonic separator 118 comprises three major components: (1) a cylindrical portion 160 having a top 166, a diameter D_{c} and a length L_{c}; (2) a conical frustum portion 162 having a length Lf and a first diameter equal to D_{c} and tapering to a second diameter Dₛₒ at the secondary outlet 122; and (3) a cylindrical vortex finder 164 having a diameter Dₚₒ, and extending from the top 166 of the cylindrical portion 160 down into the cylinder a distance or length L_{vf}. The vortex finder 164 transitions into and is in communication with the primary outlet 120. In the embodiments illustrated, all three portions 160, 162 and 164 are coaxial about a main axis 165 of the separator. This is a typical configuration and the axis is generally oriented vertically, although configurations with horizontal and nearly horizontal axes are also possible. As mentioned above a tangential inlet 116 enters and communicates with the interior of the cylindrical portion 160 near the top 166.

In operation, air laden with particulates enters the tangential inlet with an initial velocity, V₀ and the curved walls of the cylindrical portion 160 accelerate the flow radially inwardly. The initial velocity is a “high velocity” stream, essentially driven by the air flow and velocity of the blowers 108, and means any air flow greater than about 3,000 feet per minute (“fpm”), more typically in excess of 4,000 or 5,000 fpm. Depending on multiple factors such as particle size and mass, and viscosity or density of the fluid stream, the inertia of the particulate matter tends to carry it toward the outer walls, while the gas stream accelerates inwardly. This causes a separation of the particles from the fluid and the particles decelerate and (in a vertical orientation) literally “fall” from the walls down into the conical frustum 162 and out the secondary outlet 122. This deceleration results in a “low velocity” egress of particulates from the secondary outlet 122. “Low velocity” means a velocity that is no more than about 1,000 fpm, more typically less than about 500 fpm, or less than about 50 fpm, and may even be so low as to amount to no more than the terminal velocity of the particle falling under gravity alone. Meanwhile, the entraining gas stream accelerates centrally until it escapes up the vortex finder 164 and out the primary outlet 120 with a relatively high velocity.

The separation of particulates, e.g. glass or other mineral fibers, from a transporting gas stream such as air in a cyclonic separator depends on the unbalancing of multiple forces. In the simplest terms, the denser and heavier particles are flung outwardly by the rotational flow within the vortex until they reach the wall and begin to slow and drop out of the air stream. Other models ignore the effect of gravity and examine the balance (or unbalance) of: (1) the inertial centrifugal force acting to thrust the particle outwardly; (2) the buoyant forces tending to keep the particle toward the central axis; (3) the drag forces of the particle within the transporting fluid (e.g. air). Still other more complex models examine forces in the axial and radial directions, balancing buoyancy and drag vs centrifugal force in the radial direction, and buoyancy and drag vs. gravity in the axial direction. This later model assumes, of course, that the separator is oriented with its vortex in substantially vertical orientation.

As the air is removed, the particulates are concentrated and become more dense. As noted above, the density of the glass-air leaving the fiberizer (and entering the cyclone inlet) may be as low as about 0.002 pcf. By some estimates, the density of the particulates exiting the cyclone may be as low as 10 pcf, 5 pcf, 1 pcf or less. Thus, the density is increased by 2-3 orders of magnitude; or by at least 500 fold, at least 1,000 fold, at least 2,000 fold, at least 3,000 fold, at least 4,000 fold, or at least 5,000 fold.

While the velocity of particles and fibers may be decelerated essentially to terminal velocity (under the influence of gravity alone), this much deceleration is not necessary and may not always be desirable. Sufficient velocity should be maintained to ensure the fibers traverse the “proximate” distance to the conveyor. When the secondary outlets 122 are directly over the conveyor, “proximate” encompasses a greater distance since gravity will ensure the fibers reach the conveyor. However, if the fibers need to traverse any cross-gravity distance, or if they will be slowed by friction in a chute or deflector, it may be preferable to allow them to exit the separator with some velocity, albeit still a low velocity relative to the initial input velocity. The ratio of the initial “high velocity” at input to the “low velocity” at egress should be greater than 3, greater than about 10, or greater than about 50, and may even be greater than about 100.

The size of particulate that can be separated depends on multiple design factors, including the cylinder diameter D_{c}, and length L_{c}, the initial gas stream velocity and the relative densities of the particles and gas stream. Details of these are known to those skilled in the art as noted in the references incorporated above.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A manufacturing system for making a fibrous mineral product, said system comprising;
at least one fiberizing unit adapted to form fibers from a source of molten mineral, and a blower for generating a flow of gas for deflecting and transporting the fibers;
at least one cyclonic separator having an inlet for receiving the gas flow and fibers, walls shaped to decrease the momentum/velocity of fibers relative to the momentum/velocity of transporting gas, thereby dissociating the fibers from the transporting gas, a primary outlet for egress of the transporting gas, and a secondary outlet for egress of dissociated fibers; and
a collection surface disposed proximate to the secondary outlet for receiving the dissociated fibers to form a fibrous pack.

2. The manufacturing system of claim 1, further comprising
a plurality of fiberizing units each having a spinner adapted to form fibers from a source of molten mineral and a blower for generating a flow of gas for deflecting and transporting the fibers;
a plurality of cyclonic separators each having a tangential inlet for receiving the gas flow and fibers, walls shaped to decrease the momentum/velocity of fibers relative to the momentum/velocity of transporting gas, thereby dissociating the fibers from the transporting gas, a primary outlet for egress of the transporting gas, and a secondary outlet for egress of dissociated fibers, and
a collection surface disposed beneath the secondary outlets of the cyclonic separators for receiving the dissociated fibers to form a fibrous pack.

3. The manufacturing system of claim 2, wherein the separators are arranged with a vertical main axis and a secondary outlet oriented downward toward the collection surface.

4. The manufacturing system of claim 3, wherein the separators are arranged over the collection surface substantially in-line with the machine direction.

5. The manufacturing system of claim 3, wherein the separators are arranged over the collection surface with at least two separators adjacent one another in the cross machine direction.

6. The manufacturing system of claim 3, wherein the separators are arranged over the collection surface with at least two separators staggered so as to be neither in-line, nor adjacent.

7. The manufacturing system of claim 2, wherein the separators are arranged with a horizontal main axis.

8. The manufacturing system of claim 1, further comprising sprayers for coolant water, disposed upstream of separator inlet.

9. The manufacturing system of claim 1, further comprising sprayers for binder, disposed downstream from second outlet.

10. The manufacturing system of claim 1, further comprising sprayers for binder, disposed within cyclonic separator near the second outlet.

11. A method of making a fibrous mineral product comprising;
attenuating molten mineral into fibers with at least one fiberizing unit,
transporting the fibers via a high velocity flow of gas into a cyclonic separator, the cyclonic separator having a tangential inlet for receiving the gas flow and fibers, walls shaped to decrease the momentum/velocity of fibers relative to the momentum/velocity of transporting gas, thereby dissociating the fibers from the transporting gas, a primary outlet for high velocity egress of the transporting gas, and a secondary outlet for low velocity egress of dissociated fibers; and
directing the fibers from the second outlet onto a collection surface to form a fibrous pack.

12. The method of claim 11, further comprising spraying coolant water on the fibers upstream of the separator inlet.

13. The method of claim 11, further comprising spraying binder on the fibers downstream from second outlet.

14. The method of claim 11, further comprising spraying binder on the fibers within cyclonic separator near the second outlet.

15. The method of claim 11, wherein attenuating fibers further comprises spinning molten glass to fibers and attenuating them with downward jets of air.

16. The method of claim 11, wherein the fibers are directed onto the collection surface substantially under the influence of gravity alone.

17. The method of claim 11, wherein the density of the fibers is concentrated in the cyclonic separator by at least 500 fold.

18. The method of claim 11, wherein the velocity of the fibers is diminished in the cyclonic separator from a high velocity to a low velocity.
